(19) United States
(12) Patent Application Publication
(10) Pub. No.: US 2013/0341532 A1
(43) Pub. Date: Dec. 26, 2013

(54) CURING SYSTEM AND METHOD FOR MANUFACTURING METHOD THEREOF SAME

(71) Applicants: Seung-Hyun Lee, Daejeon (KR); Deok Kyun Yoon, Daejeon (KR); Dong-Soo Kim, Daejeon (KR); Seung Hwan Ko, Daejeon (KR); Hyung jin Sung, Daejeon (KR); Hyun Wook Kang, Daejeon (KR); Jun Yeob Yeo, Daejeon (KR); Suk Joon Hong, Daejeon (KR)

(72) Inventors: Seung-Hyun Lee, Daejeon (KR); Deok Kyun Yoon, Daejeon (KR); Dong-Soo Kim, Daejeon (KR); Seung Hwan Ko, Daejeon (KR); Hyung jin Sung, Daejeon (KR); Hyun Wook Kang, Daejeon (KR); Jun Yeob Yeo, Daejeon (KR); Suk Joon Hong, Daejeon (KR)

(21) Appl. No.: 14/004,445

(22) PCT Filed: Feb. 27, 2012
(86) PCT No.: PCT/KR2012/001452

§ 371 Date: Sep. 11, 2013

(30) Foreign Application Priority Data
Mar. 11, 2011 (KR) 10-2011-0021690

(51) Int. Cl. B05D 3/06

(52) U.S. Cl. CPC B05D 3/06
USPC 250/492.1

(57) ABSTRACT

A system and method for curing ink are provided. The ink curing system includes: at least one laser generator that generates laser beams of different wavelength bands having selectivity of a depth direction toward a plurality of layers in order to cure the plurality of layers that are printed as a multilayer in a thickness direction of a substrate on the substrate; and a controller that controls operation of the laser generator. Thereby, even if a layer is formed as a multilayer, because a curing time, a curing degree, and strength on a layer basis can be applied while being efficiently adjusted, a phenomenon in which a printing quality failure occurs can be reduced remarkably more than the conventional art, and because a curing time can be shortened, productivity can be improved according to decrease of a tack time.

### BACKGROUND OF THE INVENTION

(a) Field of the Invention

The present invention relates to a curing system and a curing method. More particularly, the present invention relates to a curing system and a curing method in which a phenomenon in which a printing quality failure occurs can be reduced remarkably more than the conventional art because a curing time, a curing degree, and strength on a layer basis can be applied while being efficiently adjusted, even if a layer is formed as a multilayer and in which productivity can be improved according to a decrease of a tack time because a curing time can be shortened.

(b) Description of the Related Art

Several kinds of semiconductor production apparatuses such as for chemical vapor deposition (CVD), sputtering, vacuum deposition, plating, spraying, and printing form thin film forming materials into a film on a substrate by vaporizing and patterning the thin film forming materials through exposure and developing processes or patterning the thin film forming materials while forming a film using a metal mask.

Such apparatuses lose a lot material when forming a thin film on a small substrate or repeatedly perform exposure and developing processes, thereby having disadvantageous drawbacks from a production cost viewpoint.

In order to improve such drawbacks, a patterning technology, a so-called printing electronic technology employing a printing technique, has recently been attempted.

Printing electronic technology is an entire technology that prints various functional ink materials in which a solution process is available in various electronic elements using graphic art printing.

Printing electronic technology may be divided into ink as a material, a printing technique for printing ink, and a curing method for curing the printed ink.

The ink may be subdivided into a semiconducting ink, a conducting ink, and an insulating ink according to electrical characteristics, an oxidation polymerization type of ink, an evaporation dry type of ink, a penetration dry type of ink, a precipitation dry type of ink, an ultraviolet ray curing type of ink, an infrared ray dry type of ink, and a thermosetting ink according to a dry method, a flat plate ink, a convex plate ink, a gravure ink, a screen ink, and a special ink according to a printing type, and an ink for paper, an ink for plastic, an ink for metal, an ink for wood, and an ink for pottery according to a material to be printed.

The printing technique indicates a kind of substantial printing works, and may be subdivided into an offset printing method, a gravure printing method, a gravure offset printing method, a flexography printing method, a screen printing method, and an inkjet printing method.

Finally, the curing method may be subdivided into ultraviolet-ray drying, infrared-ray drying, heat drying, electron beam drying, and laser drying.

In such printing electronic technology, a curing method is a process of curing printed ink on various electronic elements (hereinafter referred to as a substrate), and is generally performed following a printing process.

However, a curing method that is known up to now is only a method of directly radiating any one source or two or more sources of ultraviolet rays, infrared rays, heat, electron beams, and laser beams to a surface of a substrate on which ink is patterned.

Therefore, when a layer on a substrate is a multilayer instead of a single layer, a printing quality failure due to a difference in curing time, curing degree, and strength on a layer basis according to a depth direction, for example, a quality failure according to damage due to excessive heat penetration may occur, and a curing time may unnecessarily increase and thus productivity may be deteriorated due to increase of tack time and a new method is thus requested.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a curing system and a curing method in which a phenomenon in which a printing quality failure occurs can be reduced remarkably more than the conventional art because a curing time, a curing degree, and strength on a layer basis can be applied while being efficiently adjusted, even if a layer is formed as a multilayer, and in which productivity can be improved according to a decrease of a tack time because a curing time can be shortened.

An exemplary embodiment of the present invention provides a curing system including: at least one laser generator that generates laser beams of different wavelength bands having selectivity in a depth direction toward a plurality of layers in order to cure the plurality of layers that are printed as a multilayer in a thickness direction of a substrate on the substrate; and a controller that controls operation of the laser generator.

The laser generator may be a tunable wavelength laser generator (TWLG) that generates laser beams that can be changed in a band in which an oscillation wavelength is previously determined.

The laser generator may exist in plural, and the controller may be connected in parallel to the plurality of laser generators to individually control the plurality of laser generators.

The curing system may further include a wavelength converter that is connected to the laser generator and that converts a wavelength of laser beams that are provided from the laser generator.

Another embodiment of the present invention provides a curing system including: at least one laser generator that generates laser beams of different wavelength bands having selectivity in a depth direction toward a plurality of layers in order to cure the plurality of layers that are printed as a multilayer in a thickness direction of a substrate on the substrate; a laser pulse generator (LPG) that is connected to the laser generator and that generates laser beams that are provided from the laser generator in a pulse type; and a controller that controls operation of the laser generator and the LPG.

The laser generator may be a TWLG that generates laser beams that can be changed in a band in which an oscillation wavelength is previously determined.

Frequencies of laser pulses advancing to the plurality of layers may be different.

The TWLG and the LPG may be provided in plural while forming pairs, and the controller may individually control the TWLG and the LPG forming pairs.

Yet another embodiment of the present invention provides a method of curing ink, the method including: generating laser beams of different wavelength bands having selectivity in a depth direction toward a plurality of layers that are printed as a multilayer in a thickness direction of a substrate on the substrate; and selectively curing the plurality of layers with laser beams of different wavelength bands.

The method may further include generating the generated laser beams into a laser pulse.

The selectively curing of the plurality of layers may include selectively curing the plurality of layers with the laser pulse.

According to the present invention, even if a layer is formed as a multilayer, because a curing time, a curing degree, and strength on a layer basis can be applied while being efficiently adjusted, a phenomenon in which a printing quality failure occurs can be reduced remarkably more than the conventional art, and because a curing time can be shortened, productivity can be improved according to a decrease of a tack time.

Further, according to the present invention, by using laser pulses, drying and curing processes can be performed without damage or thermal deformation of a substrate.

### BRIEF DESCRIPTION OF THE DRAWINGS

FIG. 1 is a schematic diagram of an ink curing system according to a first exemplary embodiment of the present invention.

FIG. 2 is a block diagram illustrating a configuration of the ink curing system of FIG. 1.

FIG. 3 is a schematic diagram of an ink curing system according to a second exemplary embodiment of the present invention.

FIG. 4 is a schematic diagram of an ink curing system according to a third exemplary embodiment of the present invention.

FIG. 5 is a schematic diagram of an ink curing system according to a fourth exemplary embodiment of the present invention.

FIG. 6 is a schematic diagram of a laser pulse that is applied to first and second layers of FIG. 5.

FIG. 7 is a schematic diagram of an ink curing system according to a fifth exemplary embodiment of the present invention.

FIGS. 8 and 9 are photographs illustrating a result of drying or curing using a laser pulse according to an exemplary embodiment of the present invention.

FIG. 10 (a) is a photographs illustrating a result in which a multilayer substrate is dried or cured using a laser according to an exemplary embodiment of the present invention.

FIG. 10 (b) is a graph illustrating AFM scanning of a section of FIG. 10 (a).

FIG. 11 shows photographs illustrating a dried or cured result using a laser according to an exemplary embodiment of the present invention.

### DETAILED DESCRIPTION OF THE EMBODIMENTS

Other objects and advantages of the present invention will be easily understood by the accompanying drawings and exemplary embodiments of the invention. The present invention are not limited to exemplary embodiments described here and may be embodied in various forms. Exemplary embodiments introduced here are provided to thoroughly and completely disclose contents and to fully transfer the spirit or scope of the present invention to a person of ordinary skill in the art.

In this specification, when it is said that any constituent element is positioned on other constituent elements, it means the constituent element is directly on the other constituent element or above the other constituent element with at least one intermediate part. In the drawings, for better understanding and ease of description, thicknesses of constituent elements are excessively displayed.

Exemplary embodiments of this specification invention will be described with reference to cross-sectional and and/or top plan views of the present invention. In the drawings, the thickness of layers and regions are exaggerated for clarity. Therefore, a form of the drawings by production technology and/or an allowable error may be changed. Therefore, exemplary embodiments of the present invention are not limited to a shown specific form but include a change of a form generated according to a production process. For example, an etching area shown with a right angle may be formed in a round form or in a form having a predetermined curvature. Therefore, areas are illustrated in the drawings to have attributes, and a shape of areas illustrated in the drawings illustrates a specific form of an area of an element and does not limit the scope of the invention. In exemplary embodiments of this specification, terms such as “first” and “second” are used for describing various constituent elements, but the constituent elements are not limited by the terms. The terms are used only for distinguishing a constituent element from other constituent elements. Exemplary embodiments described and illustrated here include complementary exemplary embodiments thereof.

Terms used in this specification are to describe exemplary embodiments and are not intended to limit the present invention. In this specification, singular forms used include a plurality of forms unless phrases explicitly represent an opposite meaning. A meaning of “comprises” and/or “comprising” used in a specification does not exclude the presence or addition of at least one of other constituent elements.

Hereinafter, the present invention will be described in detail with reference to the drawings. When describing specific exemplary embodiments hereinafter, various specific contents are described to more specifically describe the invention and help comprehension of the invention. A person of ordinary skill in the art may recognize that the present invention can be used without such various specific contents. Detailed descriptions of well-known functions and structures incorporated herein may be omitted to avoid obscuring the subject matter of the present invention.

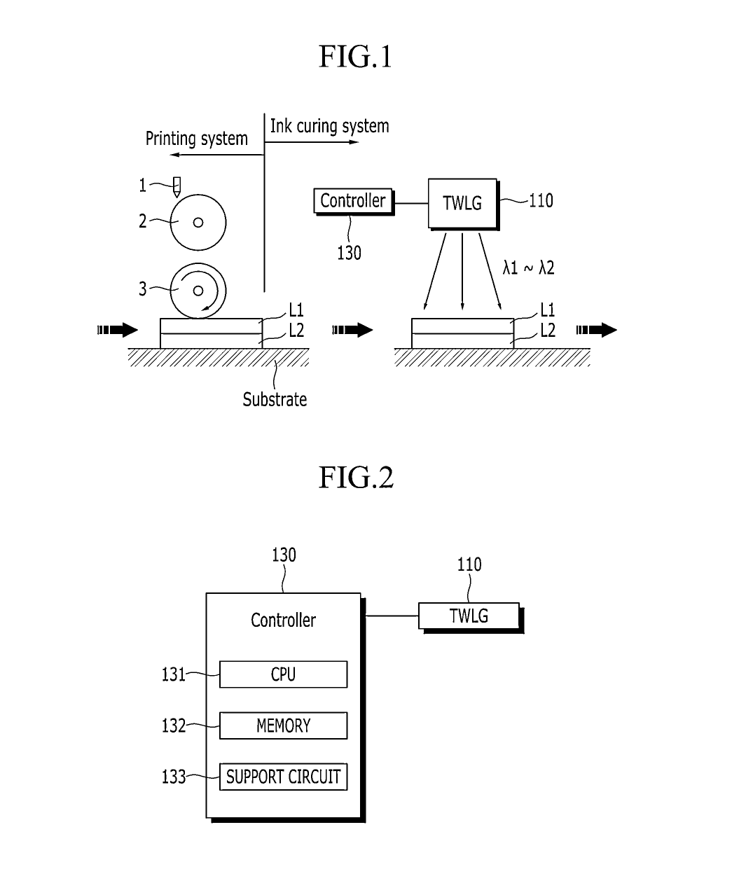

FIG. 1 is a schematic diagram of an ink curing system according to a first exemplary embodiment of the present invention, and FIG. 2 is a block diagram of the ink curing system of FIG. 1.

Referring to FIGS. 1 and 2, an ink curing system of the present exemplary embodiment may be connected with a printing system to be used, as shown in FIG. 1.

In such a case, the printing system and the ink curing system may form a printing apparatus. The system of FIG. 1 is an exemplary embodiment, and the present invention is not limited to the structure of FIG. 1.

The printing system of FIG. 1 will now be simply described. As printing electronic technology is applied, the printing system forms a single printing layer or a multiple printing layer, i.e., a layer, on a substrate. As described above, any printing method of an offset printing method, a gravure printing method, a gravure offset printing method, a flexography printing method, a screen printing method, and an inkjet printing method may be applied.

The substrate may be a flat panel display (FPD) substrate such as a liquid crystal display (LCD) substrate, a plasma display panel (PDP) substrate, or an organic light emitting diode (OLED) substrate, and it may be a semiconductor wafer or a wafer or substrate for a solar cell, and hereinafter, these are referred to as a substrate.

In FIG. 1, a gravure printing method is exemplified. That is, a gravure printing method has a configuration of a gravure roll 2 to which ink is applied at an outer surface by a dispenser 1, and a blanket roll 3 that approaches the gravure roll 2 or separates from the gravure roll 2 and that performs substantial printing work while rotating on a substrate and patterns first and second layers L1 and L2 in a thickness direction of the substrate on the substrate. In FIG. 1, the gravure roll 2 has a form of a roll, but may have a plate form.

Accordingly, when ink is transferred to an outer surface of the gravure roll 2 through the dispenser 1, the blanket roll 3 moves upward to circumscribe with the gravure roll 2 and thus the blanket roll 3 may transfer ink from the gravure roll 2, and the blanket roll 3 moves downward and again transfers ink while rotating on the substrate and thus the first and second layers L1 and L2 of a single layer or a multilayer, as shown in the drawing, may be patterned on the substrate.

As shown in FIG. 1, immediately after the first and second layers L1 and L2 are patterned on the substrate, the ink is not completely cured and thus in order to cure the ink, an ink curing system of the present exemplary embodiment may be used.

An ink curing system according to the present exemplary embodiment may include a laser generator 110 and a controller 130 that controls operation of the laser generator 110.

The laser generator 110 according to an exemplary embodiment of the present invention may generate laser beams of different wavelength bands. In the present exemplary embodiment, the laser generator 110 generates laser beams of two different wavelength bands, but this is an illustration, and the laser generator 110 may generate laser beams of at least three different wavelength bands.

By laser beams of different wavelength bands that are generated by the laser generator 110, the first and second layers L1 and L2 that are printed as a multilayer in a thickness direction of the substrate on the substrate may be selectively dried and cured.

As such a laser generator 110, in the present exemplary embodiment, a tunable wavelength laser generator (TWLG) 110 is used.

The TWLG 110 performs a function of generating laser beams that can change in a band in which an oscillation wavelength is previously determined.

The TWLG 110 may be referred to as a tuning laser generator. A tuning range may be determined according to a band of a laser medium. Lasers having a wide tuning range include solid lasers, pigment lasers, and semiconductor lasers.

Such a TWLG 110 may generate laser beams of different wavelength bands having selectivity of a depth direction so as to apply a laser beam λ1 to the first layer L1 having a relatively smaller depth and a laser beam λ2 to the second layer L2 having a relatively larger depth. Here, a wavelength of the laser beam λ1 may be different from that of the laser beam λ2. Further, a wavelength of the laser beam λ2 may be smaller than that of the laser beam λ1. Alternatively, energy density of the laser beam λ1 may be different from that of the laser beam λ2.

According to an exemplary embodiment of the present invention, by adjusting the wavelength and/or an energy density, a penetration depth of the laser beams can be adjusted.

According to an exemplary embodiment of the present invention, in order to selectively cure a wavelength, it is preferable that a size of particles that are patterned in the first layer or the second layer is uniform.

The controller 130 controls operation of an ink curing system according to the present exemplary embodiment.

Such a controller 130 may include a central processing unit (CPU) 131, a memory 132, and a support circuit 133, as shown in FIG. 2. In order to control an ink curing system of the present exemplary embodiment, the CPU 131 may be one of various computer processors that can be industrially applied. The memory 132 is connected to the CPU 131 by operation of the CPU 131. The memory 132 is a computer readable recording medium, and may be installed at a local location or a remote location, and is, for example, at least one memory that can be easily used like a random access memory (RAM), a ROM, a floppy disk, a hard disk, or a random digital storage form. The support circuit 133 is operatively coupled to the CPU 131 and supports a typical operation of a processor. Such a support circuit 133 may include a cache, a power supply, a clock circuit, an input/output circuit, and a subsystem.

For example, in an ink curing system according to the present exemplary embodiment, a series of processes for enabling the TWLG 110 to apply laser beams having different wavelength bands as the first and second layer beams L1 and L2 may be stored in the memory 132. Typically, a software routine may be stored in the memory 132. The software routine may be stored or executed by another CPU (not shown), and such other CPU (not shown) may be positioned at a location that is separated from the ink curing system.

It is described that a process according to the present invention is executed by a software routine, but at least a portion of processes of the present invention may be performed by hardware. In this method, processes of the present invention may be embodied by software to be performed in a computer system, may be embodied by hardware such as an integrated circuit, or may be embodied by a combination of software and hardware.

By such a configuration, after first and second layers L1 and L2 are patterned on a substrate through a printing system, the patterned first and second layers L1 and L2 may be cured while passing though an ink curing system of the present exemplary embodiment.

The TWLG 110 according to an exemplary embodiment of the present invention may generate a first wavelength band of laser beams for drying and curing a first layer and a second wavelength band of laser beams for drying and curing a second layer.

As described above, an ink curing system of the present exemplary embodiment may be connected with a printing system to operate, and such an operation may be preferable for improvement of productivity, but the ink curing system is not necessary connected with a printing system to operate.

In this method, according to the present exemplary embodiment, even if a layer is formed as a multilayer, because curing time, curing degree, and strength on a layer basis can be applied while being efficiently adjusted, a phenomenon in which a printing quality failure occurs can be reduced remarkably more than in the conventional art, and because curing time can be shortened, productivity can be improved according to a decrease of a tack time.

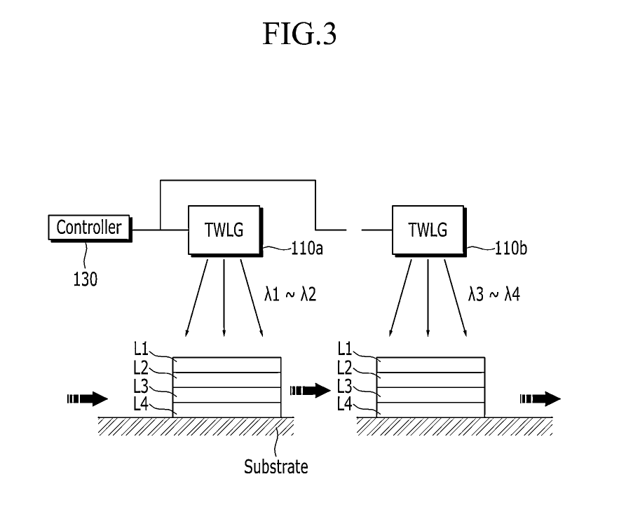

FIG. 3 is a schematic diagram of an ink curing system according to a second exemplary embodiment of the present invention.

Referring to FIG. 3, when the first and second layers L1 and L2 and third and fourth layers L3 and L4 are patterned on a substrate, an ink curing system of the present exemplary embodiment may be provided to cure the first to fourth layers L1-L4.

In this case, first and second TWLGs 110a and 110b are used to generate laser beams of different wavelength bands having selectivity in a depth direction toward the first and second layers L1 and L2 and the third and fourth layers L3 and L4 corresponding thereto, and the controller 130 is connected in parallel to the first and second TWLGs 110a and 110b to individually control the first and second TWLGS 110a and 110b.

In FIG. 3, the TWLGS 110a and 110b may generate laser beams of different wavelength bands having selectivity in a depth direction so that laser beams λ1 and λ3 having relatively small penetration depth are radiated to the first layer L1 and the third layer L3 having a relatively small depth and laser beams λ2 and λ4 having relatively large penetration depth are radiated to the second and fourth layers L2 and L4 having a relatively large depth, and thus the first to fourth layers L1-L4 can be cured. Here, the laser beams having large penetration depth may be, for example, laser beams having a short wavelength or laser beams having a high energy density.

Referring to FIG. 3, after the first layer L1 and the second layer L2 are cured, the third layer L3 and the fourth layer L4 may be cured.

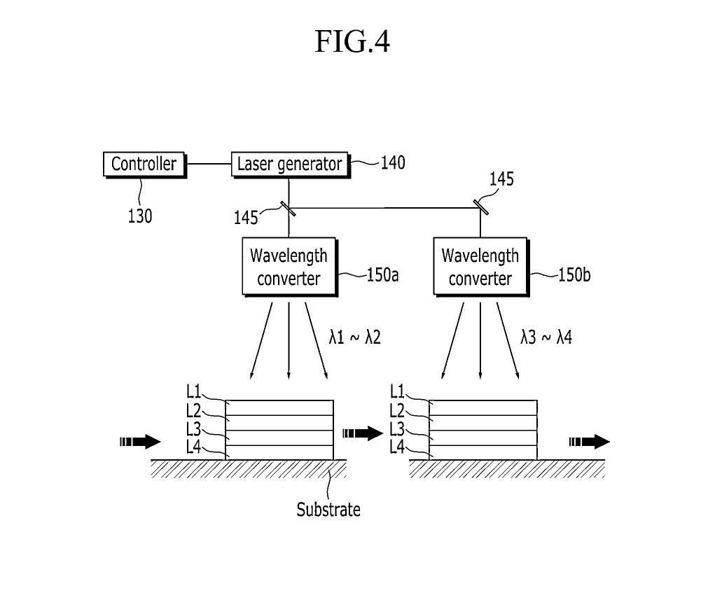

FIG. 4 is a schematic diagram of an ink curing system according to a third exemplary embodiment of the present invention.

Referring to FIG. 4, after the first and second layers L1 and L2 and the third and fourth layers L3 and L4 are patterned, an ink curing system of the present exemplary embodiment may be provided to cure the first to fourth layers L1-L4.

In this case, an ink curing system uses a laser generator 140 that generates common laser beams and has a structure in which wavelength converters 150a and 150b that convert a wavelength of laser beams that are provided from a laser generator 140 are connected to the laser generator 140. The controller 130 that is described in a first exemplary embodiment is connected to the laser generator 140.

The wavelength converters 150a and 150b may be various kinds, and for example, wavelength converters 150a and 150b in which a method of converting a wavelength using nonlinear characteristics is applied may be used. As one of methods of using nonlinear characteristics, a diode-pumped solid-state (DPSS) laser apparatus may be selected. In the DPSS laser apparatus, it is known that by applying light of a pump laser diode of an 808 nm band to a Nd:YAG crystal, after a wavelength of about 1060 nm is obtained, by raising a frequency to the diode using a nonlinear crystal, green light of about 530 nm may be obtained.

As shown in FIG. 4, in a laser path from the laser generator 140, by disposing a mirror 145 at an appropriate position, laser beams from the laser generator 140 are applied to the wavelength converters 150a and 150b, and in the wavelength converters 150a and 150b, the laser beams are converted to a wavelength band for curing the first and second layers L1 and L2 and the third and fourth layer L3 and L4 and are applied the first to fourth layers L1-L4, thereby curing the first to fourth layers L1-L4.

Even in a case that is shown in FIG. 4, the wavelength converters 150a and 150b may generate laser beams of different wavelength bands having selectivity in a depth direction so that the laser beams λ1 and λ3 having relatively small penetration depth may radiate to the first layer L1 and the third layer L3 having a relatively smaller depth and laser beams λ2 and λ4 having relatively large penetration depth may radiate to the second and fourth layers L2 and L4 having a relatively large depth, and the first to fourth layers L1-L4 may be cured through such a method.

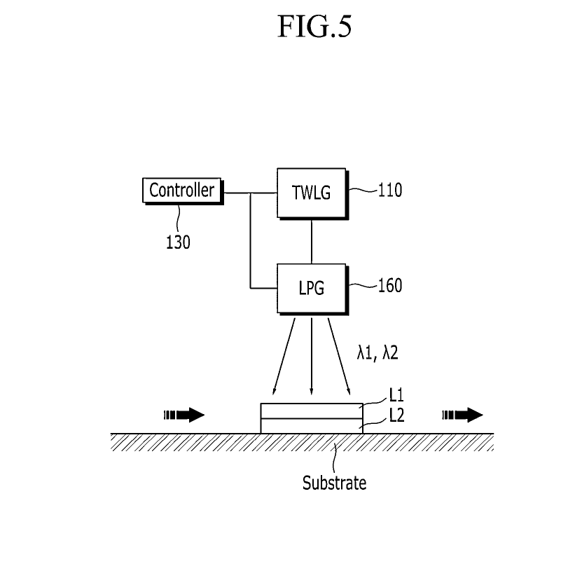

FIG. 5 is a schematic diagram of an ink curing system according to a fourth exemplary embodiment of the present invention.

Referring to FIG. 5, when first and second layers L1 and L2 are patterned on a substrate, an ink curing system of the present exemplary embodiment may be provided to cure the first and second layers L1 and L2.

Such an ink curing system may include a TWLG 110 that is described in the first exemplary embodiment, a laser pulse generator (LPG) 160 that is connected to the TWLG 110, and a controller 130 that controls them.

A function of the TWLG 110 and the controller 130 is described in the foregoing exemplary embodiment, and hereinafter, the LPG 160 will be described.

The LPG 160 is connected to the TWLG 110 and performs a function of generating laser beams that are provided from the TWLG 110 as a pulse type.

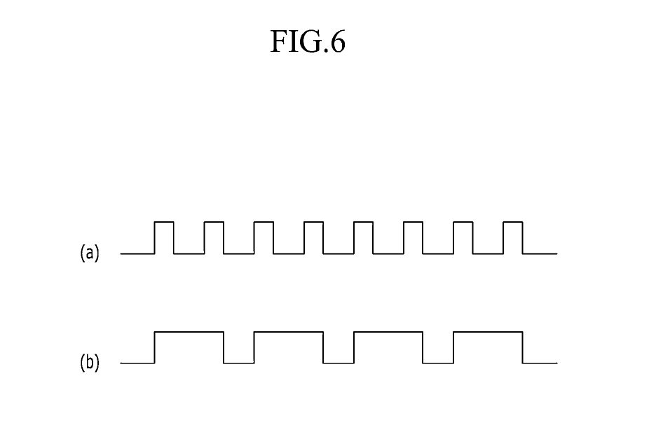

The laser beams that are generated in the TWLG 110 generally have a pulse shape, but are referred to as a laser pulse compared to a continuous wave laser. That is, when passing through the LPG 160, the laser beams are changed to a laser pulse, and as shown in FIG. 6, may be applied to the first and second layers L1 and L2.

According to an exemplary embodiment of the present invention, a layer is dried and cured using a wavelength band of a laser pulse corresponding to a layer to be dried and cured, and when the layer is formed in a multilayer substrate like the first and second layers L1 and L2, by adjusting energy density of a laser pulse, a penetration degree of the multilayer substrate may be adjusted. According to the present invention, by adjusting at least one of a wavelength of the laser beams, a cycle of laser pulses, and energy density of the laser beams, the depth of the laser beam penetration to the multilayer substrate can be adjusted.

For example, when it is assumed that two laser pulses having the same wavelength exist, in the two laser pulses, laser beams having a long pulse cycle may penetrate more deeply than laser beams having a short pulse cycle (e.g., as shown in FIG. 6 (a) and (b). For example, when it is assumed that two laser pulses having the same pulse cycle exist, in the two laser pulses, a laser pulse having a short wavelength may penetrate more deeply than a laser pulse having a long wavelength. Further, for example, when it is assumed that two laser pulses in which a wavelength and a cycle of a pulse are the same exist, in the two laser pulses, a laser pulse having a large energy density may penetrate more deeply than a laser pulse having a small energy density.

In this method, in the present invention, because a laser pulse is used and has an influence on a periphery of a surface of a substrate, the substrate may not be damaged or thermally deformed.

Laser pulses that are shown in FIG. 6 are an illustration, and different forms of laser pulses may be used for the present invention.

In the foregoing exemplary embodiments, a specific wavelength is used like a laser pulse λ1, a laser pulse λ2, a laser pulse λ3, and a laser pulse λ4, but a laser pulse may be used in a predetermined wavelength band. For example, a predetermined wavelength band such as (λ1+Δλ)−(λ1−Δλ) instead of λ1 may be used. In other wavelengths, a predetermined wavelength band may be used with a similar method.

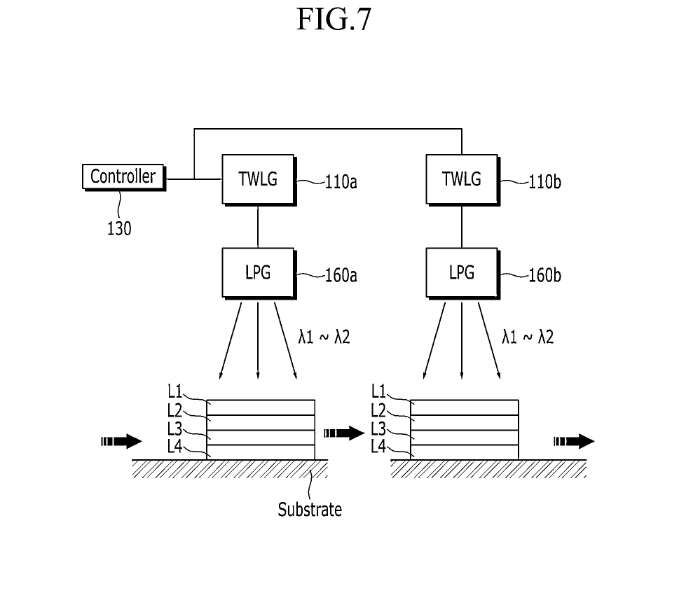

FIG. 7 is a schematic diagram of an ink curing system according to a fifth exemplary embodiment of the present invention.

Referring to FIG. 7, when first and second layers L1 and L2 and third and fourth layers L3 and L4 are patterned on a substrate, an ink curing system of the present exemplary embodiment may be provided to cure the first to fourth layers L1-L4.

In this case, first and second TWLGs 110a and 110b and first and second LPGs 160a and 160b that are connected to correspond thereto may be used, and a controller 130 is connected in parallel to the first and second

TWLGS 110a and 110b to individually control the first and second TWLGs 110a and 110b.

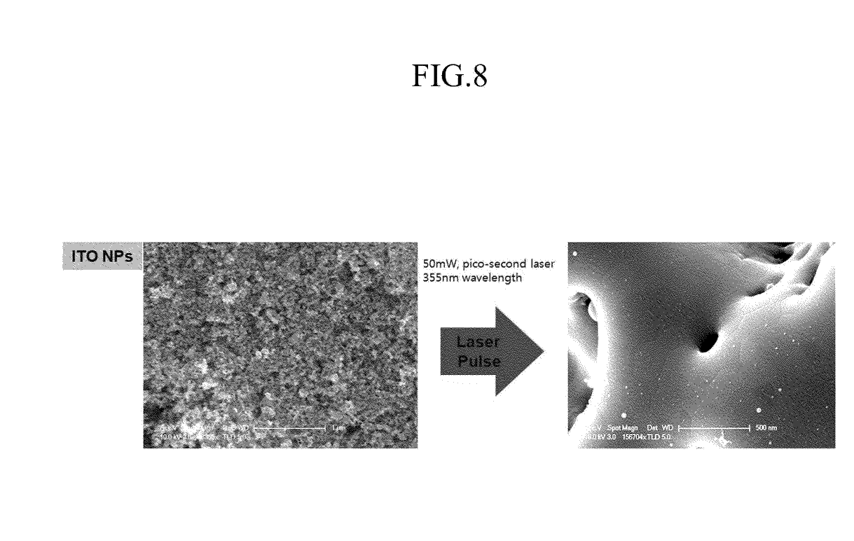

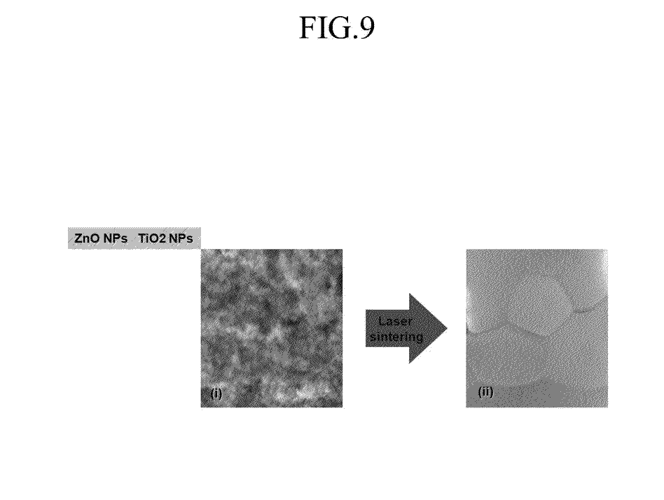

FIGS. 8 and 9 are photographs illustrating a result of drying or curing using a laser pulse according to an exemplary embodiment of the present invention.

FIG. 8 is a photograph illustrating a result in which a substrate that is patterned with ITO nanoparticles is dried and cured using a laser pulse (power 50 mW) having a wavelength of 355 nm. Referring to FIG. 8, when laser pulses according to an exemplary embodiment of the present invention are applied to patterned particles like in the left photograph, curing may be performed as shown in the right photograph of FIG. 8.

FIG. 9 is a photograph illustrating a result in which a substrate that is patterned with zinc oxide (ZnO) and titanium dioxide (TiO₂) nanoparticles is cured and dried using a laser pulse (power 50 mW) having a wavelength 55 of nm. Referring to FIG. 9, when a laser pulse according to an exemplary embodiment of the present invention is applied to patterned particles like in the left photograph, curing may be performed as shown in the right photograph of FIG. 9.

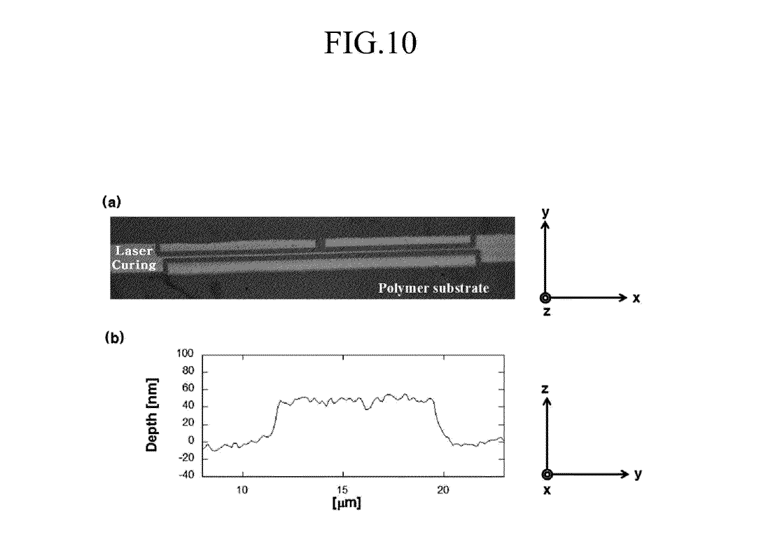

FIG. 10 (a) and (b) are photographs illustrating a result in which a multilayer substrate is dried/cured using laser beams of a specific wavelength band according to an exemplary embodiment of the present invention.

FIG. 10 (a) is a photograph (i.e., a photograph taken while viewing the −z axis direction at the +z axis) that is taken at the upper side of a polymer substrate, and FIG. 10 (b) is an atomic force microscope (AFM) scanning photograph that is taken in a section direction (i.e., a photograph that is taken while viewing the −x axis direction at the +x axis direction) of FIG. 10 (a).

The present exemplary embodiment illustrates metal nanoparticles that are patterned on a polymer substrate and that are selectively dried and cured using a YAG laser (wavelength 532 nm). Referring to FIG. 10 (a) and (b), according to the present invention, only metal nanoparticles may be selectively dried and cured without damaging a polymer substrate.

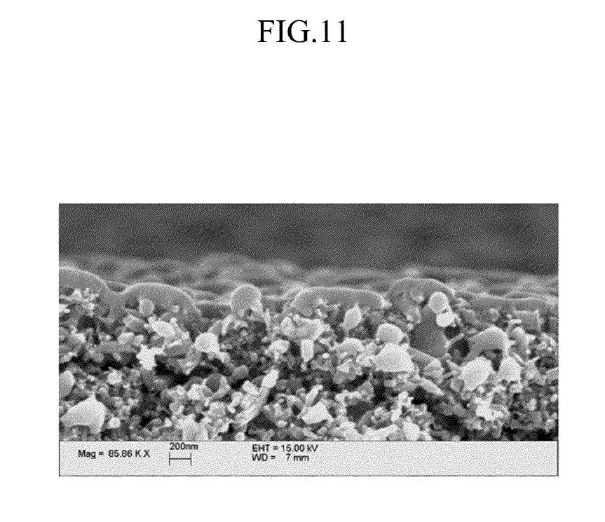

FIG. 11 is a photograph illustrating a result of drying or curing using laser beams of a specific wavelength band according to another exemplary embodiment of the present invention.

FIG. 11 illustrates a substrate in which metal nanoparticles are patterned and dried or cured using an excimer laser having a wavelength of 248 nm, and only a surface of the substrate may be dried and cured according to the present invention.

An ink curing method according to an exemplary embodiment of the present invention is provided. For example, first, a step of generating laser beams of different wavelength bands having selectivity in a depth direction toward a plurality of layers that are printed as a multilayer in a thickness direction of the substrate on a substrate may be performed, a and step of selectively curing the plurality of layers using laser beams of different wavelength bands may be performed.

Further, a step of generating the generated laser beams into a laser pulse may be performed between the step of generating the laser beams and the step of curing, and the step of curing may be a step of selectively curing the plurality of layers by the laser pulse.

In the foregoing description, the present invention has been described with reference to the drawings, but the present invention is not limited thereto.

In the foregoing exemplary embodiments, two layers are provided in a vertical direction on a substrate, but the number of layers may be three or more, and an ink curing system of the present invention can be fully applied even to this case.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

110: TWLG 130: controller

140: laser generator 150a, 150b: wavelength converter

160: LPG

What is claimed is:

1. A curing system, comprising:
at least one laser generator that generates laser beams of different wavelength bands having selectivity in a depth direction toward a plurality of layers in order to cure the plurality of layers that are printed as a multilayer in a thickness direction of a substrate on the substrate; and
a controller that controls operation of the laser generator.

2. The curing system of claim 1, wherein the laser generator is a tunable wavelength laser generator (TWLG) that generates laser beams that can be changed in a band in which an oscillation wavelength is previously determined.

3. The curing system of claim 1, wherein the laser generator exists in plural, and the controller is connected in parallel to the plurality of laser generators to individually control the plurality of laser generators.

4. The curing system of claim 1, further comprising a wavelength converter that is connected to the laser generator and that converts a wavelength of laser beams that are provided from the laser generator.

5. A curing system comprising:
at least one laser generator that generates laser beams of different wavelength bands having selectivity in a depth direction toward a plurality of layers in order to cure the plurality of layers that are printed as a multilayer in a thickness direction of a substrate on the substrate;
a laser pulse generator (LPG) that is connected to the laser generator and that generates laser beams that are provided from the laser generator in a pulse type; and
a controller that controls operation of the laser generator and the LPG.

6. The curing system of claim 5, wherein the laser generator is a TWLG that generates laser beams that can be changed in a band in which an oscillation wavelength is previously determined.

7. The curing system of claim 5, wherein frequencies of laser pulses advancing to the plurality of layers are different.

8. The curing system of claim 6, wherein the TWLG and the LPG are provided in plural while forming pairs, and the controller individually controls the TWLG and the LPG forming pairs.

9. A method of curing ink, the method comprising:
generating laser beams of different wavelength bands having selectivity in a depth direction toward a plurality of layers that are printed as a multilayer in a thickness direction of a substrate on the substrate; and
selectively curing the plurality of layers with laser beams of different wavelength bands.

10. The method of claim 9, further comprising generating the generated laser beams into a laser pulse,
wherein the selectively curing of the plurality of layers comprises selectively curing the plurality of layers with the laser pulse.
